(19) United States
(12) Patent Application Publication
(10) Pub. No.: US 2004/0032134 A1
(43) Pub. Date: Feb. 19, 2004

(54) Anchor and hoist ring device

(76) Inventor: David C. Hageman, Chagrin Falls, OH (US)

Correspondence Address: REISING, ETHINGTON, BARNES,, KISSELLE, LEARMAN & MCCULLOCH, PC, P.O. BOX 4390, TROY, MI, 48099-4390, US

(21) Appl. No.: 10/217,576

(22) Filed: Aug. 13, 2002

(51) Int. Cl. B66C 1/66

(52) U.S. Cl. 294/1.1; 294/89

(57) ABSTRACT

An anchor and hoist ring 10 is connected to an anchor assembly 12. The anchor and hoist ring has legs 20 that are integrally formed with the arms 18 of the ring and are canted upwardly and inwardly toward the bight section 16 of the ring 10. The ring is interlocked to the anchor assembly 12 via a swivel unit 50 that has bearing pockets 54 with bearing surfaces 54 that are complementarily sloped with the cant of the upper bight facing surface 64 of the leg to form a bearing surface thereto.

### TECHNICAL FIELD

The field of this invention relates to a swivel anchor and hoist ring device for attachment to a load for anchoring or hoisting the load.

### BACKGROUND OF THE DISCLOSURE

Swivel anchor and hoist ring devices have long been used for attachment to a load that is anchored down or lifted by a chain or cable that is connected to ring that is pivotably mounted to an anchor member of the device. Usually these anchor and hoist rings are used to lift heavy loads from multiple angles that can exert great tensile loads on the anchor and hoist ring elements of the device. As such, these members must have adequate strength to resist these tensile loads. The members are often made of steel and have great mass to provide the needed strength.

Another way to provide the necessary strength is to provide a positive interlock between the arms or legs of the anchor and hoist ring and the anchor element. Such positive interlocks are shown in U.S. Pat. Nos. 4,641,986 and 5,248,176. These two disclosures show previous attempts to provide additional strength in an attempt to prevent the arms of the anchor and hoist ring from spreading while under the tensile load.

The previous attempts for added strength either adds excess weight to the anchor and hoist ring or provides the interlock at the weakest structural point of the anchor and hoist ring thus rendering the interlock ineffective.

What is needed is an improved anchor and hoist ring device with improved interlock for increased strength and less added weight to the anchor and hoist ring.

### SUMMARY OF THE DISCLOSURE

In accordance with one aspect of the invention, an anchor and hoist device for anchoring and lifting loads includes an anchor assembly connectable to a base member. A swivel unit has a swivel engagement to the anchor assembly. A pivotable anchor and hoist ring member has a bight section, integrally formed opposed side arms and two legs inwardly extending which are integrally formed with the side arms of the hoist ring member. Each leg is canted at an angle from a base to a distal end thereof such that it to angles back toward the bight section. Bearing pockets in the swivel unit at diametrically opposite ends of the swivel unit receive and positively engage the legs of the anchor and hoist ring member.

A surface of the swivel unit forms part of the bearing pocket and is canted the same degree as the legs to provide a bearing contact between the legs and swivel unit. The bearing pockets have an open end that is closed by the anchor assembly when in a fully assembled condition. The legs have a thickness great enough to be locked into the bearing pockets by the anchor assembly when fully assembled with the swivel unit.

Preferably, the legs have a bight facing surface section that is complementarily sloped to the surface of the swivel unit forming part of the bearing pocket.

It is also desirable that legs are canted upwardly less than 30° and more than 10° from the horizontal rotational axis of the legs toward the bight section. It is desirable that legs are canted approximately 15° from said horizontal rotational axis of the legs toward the bight section.

It is also preferred that the legs have substantially the same cross-sectional area along their entire axial lengths.

According to another aspect of the invention, the anchor assembly includes a base washer with a central aperture. A top washer spaced from the base washer has a central aperture. A sleeve has an aperture and extends between said base and top washers. The aperture of the sleeve is coaligned with the apertures of the base washer and the top washer. The swivel unit is interposed between the base and top washers about the sleeve. An anchor bolt extends through the coaligned apertures and securable to the base member. Preferably the sleeve is interposed between and abuts the base and top washers.

### BRIEF DESCRIPTION OF THE DRAWINGS

Reference now is made to the accompanying drawings in which:

FIG. 1 is a front elevational and partially segmented view of an anchor and hoist ring assembly in accordance with one embodiment of the invention.

FIG. 2 is side elevational view of the anchor and hoist ring assembly shown in FIG. 1;

FIG. 3 is a perspective and exploded view of the anchor and hoist ring assembly shown in FIG. 1;

FIG. 4 is a front elevation view of the anchor and hoist ring shown in FIG. 1;

FIG. 5 is a fragmentary and enlarged view of the anchor and hoist ring connection to the anchor assembly shown in FIG. 1;

FIG. 6 is a view similar to FIG. 5 illustrating an second embodiment of the invention; and

FIG. 7 is a fragmentary view of the base washer shown in FIG. 6.

### DETAILED DESCRIPTION OF THE PREFERRED EMBODIMENT

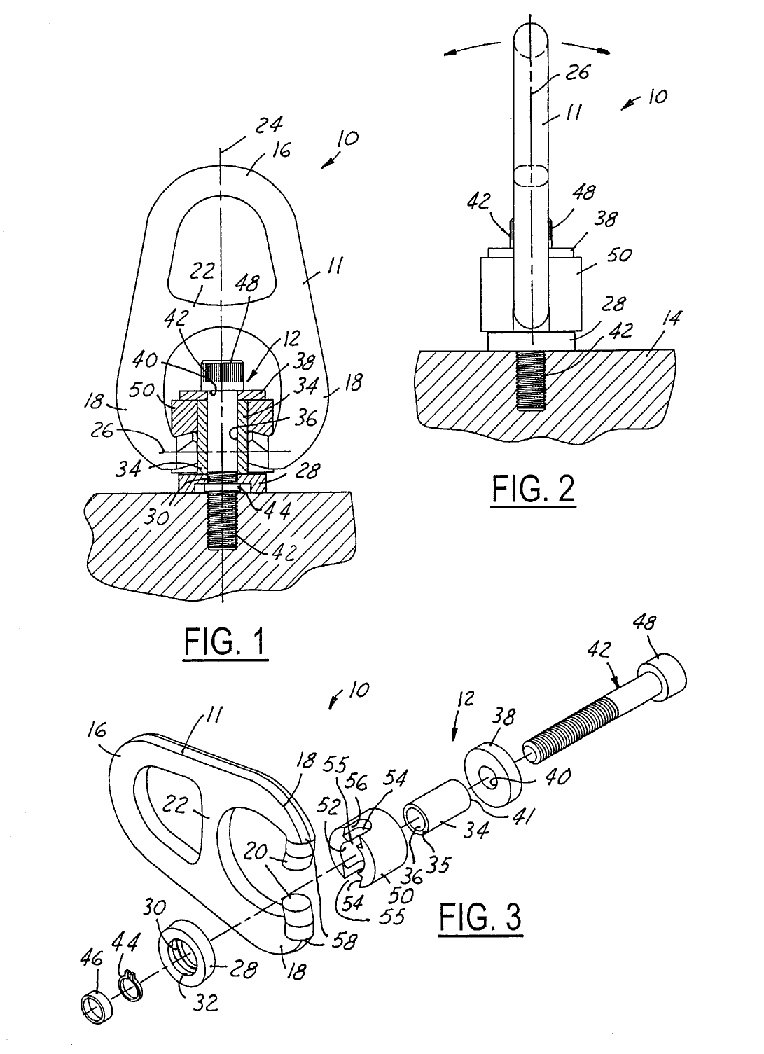

Referring now to FIGS. 1-5, an anchor and hoist device 10 includes and an anchor and hoist ring member 11 is swivably connected to an anchor assembly 12 which is connected to a load or base 14. The ring 10 has a bight section 16 and two downwardly extending arms 18 integrally formed with two inwardly and canted leg sections 20. A reinforcing intermediate bight section 22 may also be formed with the ring 10.

The anchor and hoist ring member 11 is pivotable relative to the anchor assembly 12 about both the vertical axis 24 and the horizontal axis 26 as shown in FIG. 1. The anchor assembly includes a base washer 28 positioned against the load 14. The base washer 28 has a central aperture 30 therethrough and a recessed section 32.

A central sleeve 34 has a central aperture 36 and has its bottom end 35 abutting the bottom washer 28. A top washer 38 has a central aperture 40 and abuts the top end 41 of sleeve 34. All the apertures 30, 36, and 40 are aligned to receive the bolt 42. A retaining ring 44 and shrink tubing 46 are received in the recess section 32 for retaining the entire anchor and hoist device 10 as an assembled unit between the retaining ring 44 and the head 48 of the bolt 42.

A swivel unit 50 i.e. bonnet is also interposed between the washers 28 and 38 and is pivotable about the sleeve 34. The swivel unit 50 has a central aperture 52 for being mounted about the sleeve 34 and bolt 42. In addition, the swivel unit has two bearing pockets 54 at diametrically opposite sides of the swivel unit. The bearing pockets 54 have sloped inner surfaces 56 which bear against the legs 20 of the anchor and hoist ring 11. The open bottom ends 55 of bearing pocket 24 are closed by washer 28 when the hoist and anchor device is fully assembled.

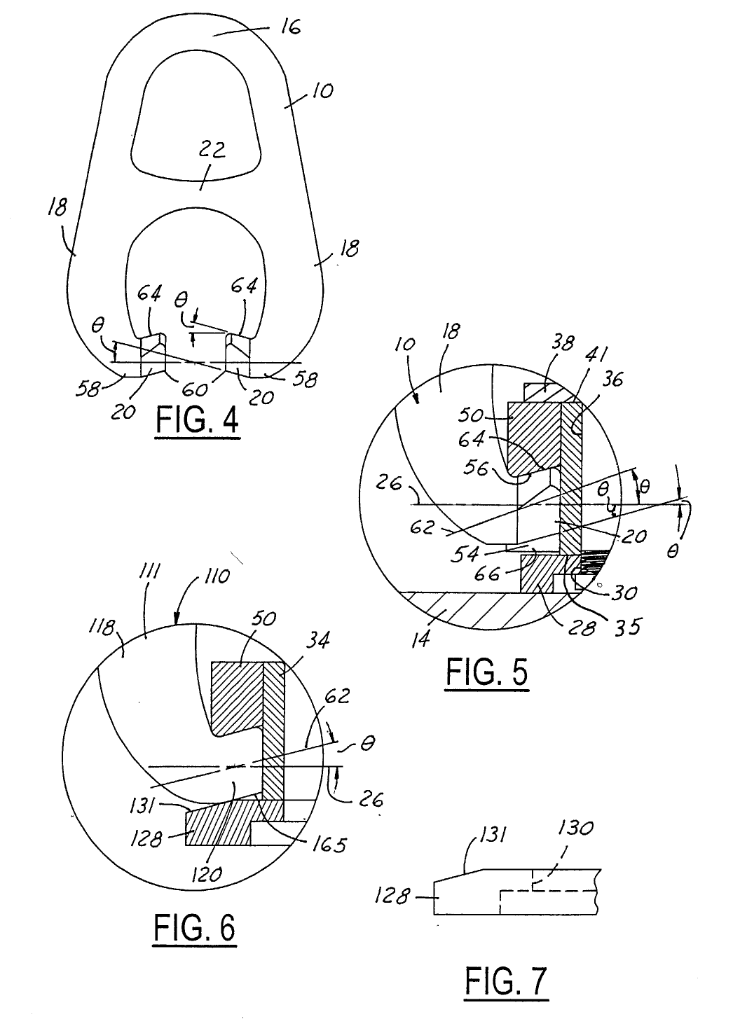

A shown more clearly in FIGS. 4 and 5, the legs 20 extend inwardly and upwardly from its integral connected end 58 to arm 10 to its distal end 60. As shown in FIG. 4 the legs have an angle θ pointed upwardly from the horizontal axis 26 upwardly toward the bight section 16. The angle may range from 10-30° with a preferred angle of approximately 15°.

It is also noted that the leg 20 has approximately the same cross sectional area from its connected end 58 to its distal end 60. In other words, one may say that the axis 62 of leg 20 is angled by 0 from the horizontal axis.

It is also made clear in FIG. 5 that the angle θ of the upper bight facing surface 64 of the leg is complementarily sloped with the sloped surface 56 of pocket 54 such that a bearing contact area is formed between the two surfaces 56 and 64. Leg 20 also has sufficient thickness such that as shown in FIG. 5, when the anchor assembly is fully installed, the leg has a positive interlock between the swivel unit 50 and its sloped surface 56 and the bottom washer 28. Any existing gap 66 between the leg 20 and bottom washer 28 is less than the dimensional vertical extent of downwardly sloping of surface 56 and its bearing contact with upper bight facing surface 64.

When the anchor assembly 12 fully assembled and installed onto load 14, the anchor and hoist ring 10 is capable of swiveling about vertical axis 24 about a fill 360° as well as rocking or pivoting about horizontal axis 26 about a full 180°. This pivoting and swiveling allows for the proper positioning of the anchor and hoist ring member for a connection to a tie, chain, cable or other tensile exerting member.

A second embodiment 110 is disclosed in FIGS. 6 and 7. In this embodiment the bottom washer has a tapered or frusto conical section 131 that is canted the same angle θ from the horizontal axis 26 to form a clearance surface for the lower surface 165 of leg 120 of anchor and hoist ring 111 as it pivots about the horizontal axis 26. The leg 120 may thus be extended more outwardly and lower relative to the leg 20 of the first embodiment where it is integrally formed with arm 118. The tapered section 131 provides also that leg 120 may be thicker compared to leg 20 of the first embodiment. The leg 120 still has substantially uniform cross sectional area along its axis 62.

In both embodiments the legs 20, 120 remain interlocked within the swivel unit 50 to the anchor assembly when the anchor assembly is fully assembled.

Variations and modifications are possible without departing from the scope and spirit of the present invention as defined by the appended claims.

The embodiments in which an exclusive property or privilege is claimed are defined as follows:

1. An anchor and hoist device for anchoring and lifting loads comprising:
an anchor assembly connectable to a base member;
a swivel unit having a swivel engagement to the anchor assembly;
a pivotable anchor and hoist ring member having a bight section, integrally formed opposed side arms and two legs inwardly extending which are integrally formed with the side arms of the hoist ring member;
each leg being canted at an angle from a base end to a distal end thereof such that it to angles back toward the bight section;
bearing pockets at diametrically opposite ends of said swivel unit for receiving and positively engaging said legs of said anchor and hoist ring member;
a surface of said swivel unit forming part of said bearing pocket being canted the same degree as said legs to provide a bearing contact between the legs and swivel unit;
said bearing pockets having an open end that is closed by said anchor assembly when in a fully assembled condition;
said legs having a thickness great enough to be locked into said bearing pockets by said anchor assembly when fully assembled against said swivel unit.

2. An anchor and hoist device as defined in claim 1 further comprising
said legs having a bight facing surface section that is complementarily sloped to said surface of said swivel unit forming part of said bearing pocket.

3. An anchor and hoist device as defined in claim 2 further comprising:
said legs being canted upwardly less than 30° and more than 10° from the horizontal axis between said legs toward the bight section.

4. An anchor and hoist device as defined in claim 3 further comprising:
said legs being canted approximately 15° from said horizontal axis extending between said legs toward the bight section.

5. An anchor and hoist device as defined in claim 4 further comprising:
said legs having substantially the same cross-sectional area along their entire axial lengths.

6. An anchor and hoist device as defined in claim 5 further comprising:
said anchor assembly including a base washer with a central aperture;
a top washer having a central aperture;
a sleeve with an aperture and extending between said base and top washers;
said aperture of said sleeve coaligned with said apertures of said base washer and said top washer;
said swivel unit interposed between said base and top washers about said sleeve;
an anchor bolt extending through said coaligned apertures and securable to said base member.

7. An anchor and hoist device as defined in claim 6 further comprising:
said sleeve being interposed between and abutting said base and top washers.

8. An anchor and hoist device as defined in claim 2 further comprising:
said anchor assembly including a base washer with a central aperture;
a top washer having a central aperture;
a sleeve with an aperture and extending between said base and top washers;
said aperture of said sleeve coaligned with said apertures of said base washer and said top washer;
said swivel unit interposed between said base and top washers about said sleeve;
an anchor bolt extending through said coaligned apertures and securable to said base member.

9. An anchor and hoist device as defined in claim 8 further comprising:
said sleeve being interposed between and abutting said base and top washers.

10. An anchor and hoist device as defined in claim 1 further comprising:
said anchor assembly including a base washer with a central aperture;
a top washer having a central aperture;
a sleeve with an aperture and extending between said base and top washers;
said aperture of said sleeve coaligned with said apertures of said base washer and said top washer;
said swivel unit interposed between said base and top washers about said sleeve;
an anchor bolt extending through said coaligned apertures and securable to said base member.

11. An anchor and hoist device as defined in claim 10 further comprising:
said sleeve being interposed between and abutting said base and top washers.

12. An anchor and hoist device as defined in claim 11 further comprising:
said legs having substantially the same cross-sectional area along their entire axial length.

13. An anchor and hoist device for anchoring and lifting loads comprising:
an anchor assembly connectable to a base member;
a swivel unit having a swivel engagement to the anchor assembly;
a pivotable anchor and hoist ring member having a bight section, integrally formed opposed side arms and two legs inwardly extending which are integrally formed with the side arms of the hoist ring member;
bearing pockets at diametrically opposite ends of said swivel unit for receiving and engaging said legs of said anchor and hoist ring member;
a surface of said swivel unit forming part of said bearing pocket for providing a bearing contact between the legs and swivel unit;
said bearing pockets having an open end that is closed by said anchor assembly when in a fully assembled condition;
said anchor assembly including a base washer with a central aperture;
a top washer having a central aperture;
a sleeve with an aperture and extending between said base and top washers;
said aperture of said sleeve coaligned with said apertures of said base washer and said top washer;
said swivel unit interposed between said base and top washers about said sleeve;
an anchor bolt extending through said coaligned apertures and securable to said base member.

14. An anchor and hoist device as defined in claim 13 further comprising:
said sleeve being interposed between and abutting said base and top washers.

15. An anchor and hoist device as defined in claim 14 further comprising:
said legs having substantially the same cross-sectional area along their entire axial length.
